(19) United States
(12) Patent Application Publication
(10) Pub. No.: US 2018/0158100 A1
(43) Pub. Date: Jun. 7, 2018

(54) IDENTIFYING AND CUSTOMIZING DISCOVERY OF OFFERS BASED ON SOCIAL NETWORKING SYSTEM INFORMATION

(71) Applicant: Facebook, Inc., Menlo Park, CA (US)

(72) Inventors: Dan Barak, Redwood City, CA (US); John Stephen Ketchpaw, Seattle, WA (US)

(21) Appl. No.: 15/370,760

(22) Filed: Dec. 6, 2016

(51) Int. Cl. G06Q 30/02; H04L 29/08; H04L 12/26; G06Q 50/00

(52) U.S. Cl. CPC G06Q 30/0255; H04L 67/22; H04L 43/045; G06Q 50/01; H04L 67/306; G06Q 30/0269; H04L 67/18

(57) ABSTRACT

The present disclosure is directed toward systems and methods for identifying and providing offers to social networking system users. For example, systems and methods described herein determine various characteristics associated with a social networking system user and identify offers available via the social networking system that are relevant to the social networking system user. In at least one embodiment, systems and methods described herein generate a discovery space that includes the identified offers in a ranked order such that the social networking system user can easily browse the offers tailored to the user's interests.

### CROSS REFERENCE TO RELATED APPLICATIONS

N/A

### BACKGROUND

E-commerce is quickly becoming a preferred method of selling goods over brick-and-mortar stores. For example, retailers are finding that purchasers prefer the ease and convenience of shopping online from home. It was once thought that the online retail experience was inferior to shopping in-person since an online purchaser must wait a few days to take possession of a purchase. Any inconvenience an online shopper experiences due to having to wait for a delivery, however, seems to be outweighed by the fact that an online shopper can buy virtually any good at any time online.

Typical e-commerce retailers, however, fail to provide a personalized shopping experience. For example, a typical e-commerce retailer, at most, has access to a history of a user's interactions with that retailer (e.g., the user's clicks within the retailer's website, the user's purchase history with that retailer, etc.). As such, the retailer can only provide purchase suggestions based on the user's previous interactions. Such suggestions, however, fail to take into account any other information about the user. For example, a user's interactions with a single e-commerce retailer are rarely indicative of the user's gender, age, location, occupation, hobbies, relationship status, and so forth. Accordingly, the e-commerce retailer's purchase suggestions often fail to suggest anything truly useful to the user and generally lead to a one-dimensional and boring shopping experience.

Accordingly, there are many disadvantages to current methods of presenting purchase offers to a user.

### SUMMARY

One or more embodiments described herein provide benefits and/or solve one or more of the foregoing or other problems in the art with systems and methods for identifying purchase offers specific to a user. For example, systems and methods described herein analyze a user's social networking system activities in order to identify offers available via the social networking system that are applicable (e.g., of greatest interest) to the user. In one or more embodiments, systems and methods described herein also rank the identified offers in order to present the most applicable offers to the social networking system user first.

Furthermore, one or more embodiments described herein solve one or more problems in the art with systems and methods for providing offers to a user via a social networking system. For example, systems and methods described herein provide identified and ranked offers to a social networking system user in an offer discovery graphical user interface. In one or more embodiments, the offer discovery graphical user interface provides the user with a space to easily view and interact with offers provided specifically for the user based on the user's social networking system activities.

Additional features and advantages of the present application will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description of the aspects of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of scope, one or more embodiments will be described and explained with additional specificity and detail through the use of the accompanying drawings in which:

FIGS. 1A-1C illustrate a series of graphical user interfaces in accordance with one or more embodiments;

FIG. 2 illustrates a detailed schematic diagram of an offer management system in accordance with one or more embodiments;

FIG. 3 illustrates a flowchart of a series of acts in a method of identifying and providing an offer to a social networking system user;

FIG. 4 illustrates a block diagram of an exemplary computing device in accordance with one or more embodiments;

FIG. 5 is an example network environment of a social networking system in accordance with one or more embodiments; and

FIG. 6 illustrates a social graph in accordance with one or more embodiments.

### DETAILED DESCRIPTION

One or more embodiments described herein provide benefits and/or solve one or more of the foregoing or other problems in the art with systems and methods for identifying and providing offers to a social networking system user. For example, the offer management system monitors a user's social networking system activity. In one or more embodiments, the offer management system analyzes the user's monitored activity to identify one or more available offers that apply to the user. In at least one embodiment, the offer management system further ranks the identified offers in order to determine which of the identified offers are most applicable to the user.

Furthermore, one or more embodiments described herein generate and provide a discovery graphical user interface that is personalized to the social networking system user. For example, after identifying and ranking offers based on the user's monitored social networking system activity, the offer management system generates the discovery graphical user interface including a listing of the ranked offers. In additional embodiments, the offer management system also includes paid or sponsored offers in the user's discovery graphical user interface that are applicable to the user.

To illustrate, one or more merchants and/or companies can collaborate with a social networking system to provide advertisements and offers to social networking system users. In one or more embodiments, the social networking system generates structured objects corresponding to each advertisement and/or offer, stores the generated structured objects in a social graph, and places display elements associated with these structured objects in various locations within the social networking system where a social networking system user can view them. For example, the social networking system can place display elements associated with structured objects in the header, footer, or margins of a graphical user interface (e.g., as with banner ads) including content for consumption by the user. Additionally, the social networking system can place display elements associated with structured objects within a user's newsfeed. In that case, the social networking system intersperses the display elements with posts from one or more of the user's social networking system friends. For ease of explanation, display elements associated with an offer's structured object are referred to herein simply as offers. Thus, it will be understood that when the offer management system includes an offer in a graphical user interface, the offer management system is including a display element associated with a structured object for that offer in the graphical user interface. Furthermore, it will also be understood that a structured object stored within the social graph for an offer may also be referred to herein as an offer.

In using the social networking system, a social networking system user generates a history of social networking system activity that is generally unrelated to e-commerce activity. For example, in one or more embodiments, social networking system activity goes beyond web browsing or application browsing. To illustrate, the social networking system user can write and view posts, comment on posts, send electronic messages, “like” posts, share posts, upload digital pictures and videos, click links, scroll through a newsfeed, interact with multimedia (e.g., standard videos, GIFs, digital photographs, 360 degree videos, etc.), and so forth. Additionally, the social networking system user maintains a profile with the social networking system. The profile can include the user's demographic information (e.g., age, occupation, location, etc.), relationship status (e.g., single, married, etc.), family member information (e.g., parents, siblings, children, nieces and nephews, grandchildren, etc.), interests, educational history, and so forth. In one or more embodiments, the offer management system monitors all social networking system activity in which the user engages as well as the user's profile information in order to infer various characteristics about the user.

For example, the offer management system can analyze a user's profile information to determine the user is male, mid-twenties, single, college graduate, and employed full-time. Next, the offer management system can analyze the user's monitored social networking system activity including posts and articles the user has “liked,” posts and articles the user has shared, hyperlinks clicked on by the user, and so forth. Through analysis, the offer management system can determine that the social networking user is interested in travel (e.g., because the user has “liked” multiple posts of friends vacation pictures), enjoys golfing (e.g., because the user has tagged himself in multiple digital photographs taken at various golf courses), and typically spends his weekends with friends (e.g., because the user frequently mentions hanging out in electronic messages among a core group of social networking system users). In this way, the offer management system identifies user characteristics without accessing any information related to the user's commercial activities (e.g., web purchases, e-commerce website browsing, etc.).

With these user characteristics identified, the offer management system identifies one or more offers available via the social networking system that apply to the social networking system user. As mentioned above, merchants and companies collaborate with the social networking system to present offers to social networking system users. Accordingly, the social networking system, over time, amasses a repository of offers that can be made available to social networking system users. Thus, the offer management system identifies one or more offers that apply to the social networking system user by matching the user's characteristics to the one or more offers.

In one or more embodiments, the social networking system generates a structured object (e.g., a node within a social graph) for each offer that includes multimedia (e.g., digital pictures, video, etc.), text, hyperlinks, and metadata (e.g., keywords, expiration information, eligibility restrictions, etc.). For example, an offer's structured offer may include keywords such as, “vacation,” “travel,” “cruise.” If the user's identified characteristics indicate the user enjoys traveling, the offer management system can determine that this offer applies to the user. Similarly, if the user's profile information indicates the user is recently engaged, the offer management system can determine that offers for wedding related goods apply to the user.

In one or more embodiments, the social networking system can connect an offer's node (e.g., the offer's structured object) to other nodes within the social graph. For example, the social networking system can tie an offer's node to another node dedicated to a product that the offer references. In one or more embodiments, the social networking system connects an offer node to an additional node in the social graph via a social graph edge, and/or via a unique identifier (e.g., such as a key value) stored by both connected nodes as an index. In at least one embodiment, the social networking system can utilize this connection between nodes to reference, for example, product information in generating a display element for the offer.

Once the offer management system identifies a number of offers that apply to the social networking system user, the offer management system next ranks the identified offers to determine which offers are likely most interesting to the user. In one or more embodiments, in order to rank the identified offers, the offer management system calculates an affinity score for each offer that indicates an affinity level between the social networking system user and the offer. For example, the offer management system calculates the affinity score for a particular offer by adding a weighted value to the affinity score for each element in common between the user's identified characteristics and characteristics of the offer. In one or more embodiments, the offer management system can also calculate the affinity score based on one or more edges connecting a node associated with the user and a node associated with the offer in a social graph, as will be described in greater detail below.

The offer management system adds a weight to certain elements that indicate a higher likelihood that the user will be interested in a particular offer. For example, if the user's identified characteristics indicate the user has recently experienced, or will soon experience, an event (e.g., the user has gotten married, had a baby, graduated from college, etc.), the offer management system can add extra weight to those characteristics associated with an offer's structured object. To illustrate, if the user has recently gotten engaged (e.g., as indicated by the user's profile information, posts, and photograph uploads), the offer management system can add extra weight to the value being added to the affinity score for a particular offer when the structured object associated with the offer indicates the offer is related to weddings. In at least one embodiment, the offer management system can add less weight to the value being added to the affinity score when the milestone is no longer recent. For example, in one embodiment, if the user had a baby 36 months ago, the offer management system adds a lighter weight to the value being added to the affinity score for a “Buy One Get One Free” baby clothes offer than if the user had had the baby 3 months ago.

After the offer management system has calculated an affinity score for each identified offer that applies to the social networking system user, the offer management system ranks each offer based on its score and generates a display of the ranked offers. For example, the offer management system can order the offers in descending order based on their ranks, such that the offers with the highest affinity score are listed first. In one or more embodiments, the offer management system generates a display that includes the ordered list of offers such that the user sees the offers most likely to be interesting to him first. In at least one embodiment, the offer management system represents each offer in the display by its structured object with which the user may interact.

Accordingly, as described above, the offer management system identifies and provides offers to a user based on monitored activity that is unrelated to e-commerce. For example, the offer management system can monitor the user's recent vacation picture uploads. The offer management system can then determine, based on the picture uploads and other social networking system activity, that the user enjoys traveling. The offer management system then identifies and provides travel offers to the user. Thus, the offer management system has provided a product offer based on user activities that are non-commercial.

Similarly, as described above, the offer management system identifies and provides offers to a user based on monitored activity that is unrelated to the user's web browsing activities. For example, the offer management system can monitor the user's live video stream broadcast during a rock concert. From this monitored activity, the offer management system can determine the user enjoys concerts and other similar events. The offer management system can then identify and provide offers for event tickets, band merchandise, and so forth. In another example, the offer management system can monitor for specific events in the user's life in among the user's social networking system activity. For example, in response to the user changing a relationship status in his profile from “single” to “married,” the offer management system can update various determinations related to the user in order to identify and provide offers to the user. Again, the offer management system has utilized user specific information that would not be readily apparent based on general web-browsing history (e.g., stored in cookies, or other temporary Internet files) to provide product offers to the user based on the user's non-web-browsing activities.

In some embodiments, the offer management system can include sponsored offers along with the other ranked offers. For example, a merchant may arrange with the social networking system to display an offer to a given percentage of social networking system users who match certain parameters. Accordingly, when a social networking system user matches the defined parameters, the offer management system can include the sponsored offer in the user's generated display of ranked offers. In at least one embodiment, the offer management system indicates that the sponsored offer is different from the other ranked offers listed in the display (e.g., by displaying paid offers at the top of the display, by marking the sponsored offers as “Sponsored,” etc.).

In response to the offer management system generating the display of ranked offers to the user, the user can select one or more offers. For example, the user can select an offer by clicking or tapping on a display element associated with the offer's structured object. In response to the user's selection, the offer management system can display additional information associated with the offer, apply the offer to a wallet, transfer the user to a third party website, etc.

In at least one embodiment, the offer management system can push offers to a social networking system user based on the user's geographic location. For example, the offer management system can determine the location of a client-computing device associated with the user (e.g., the user's mobile phone, tablet, laptop, etc.), and identify offers that not only apply to the user based on the user's identified characteristics, but also apply to merchants or businesses that are near the user's current location. To illustrate, the user may be walking through a shopping mall. In response to determining the user's location and that the user is likely going on vacation soon (e.g., based on the user's electronic messages, hyperlink clicks, and likes), the offer management system may identify an offer for 10% of swimsuits at a store located within the shopping mall.

Additionally, in one or more embodiments, the offer management system can provide additional offers to a user in response to the user selecting a particular offer. For example, in at least one embodiment, the offer management system adds extra emphasis on offers that are related to an offer that the user has actually selected. Thus, over time, the offer management system is more likely to present offers to the user with which the user is likely to interact. To illustrate, if the user selects an offer for a grocery discount at a local grocery store, the offer management system can add extra weight to subsequent grocery offers. Thus, the offer management system will rank subsequent grocery offers higher, and the user will be more likely to interact with the subsequent grocery offers. In at least one embodiment, the offer management system can immediately provide additional related offers to the user based on the user's selection of a first offer in the form of a scrolling display or popup.

Accordingly, the offer management system provides personalized offers to a user by utilizing a wealth of information beyond that which would be available to a typical e-commerce retailer. For example, as described above, the offer management system can access information related to a user that is specific to the user's purchase activities. In addition, the offer management system can access information related to the user that is unrelated to any e-commerce activity. By utilizing this unique wealth of information specific to the user, the offer management system provides a personalized selection of offers to the user in which the user is very likely to be interested. This saves both the user and the retailer time and hassle.

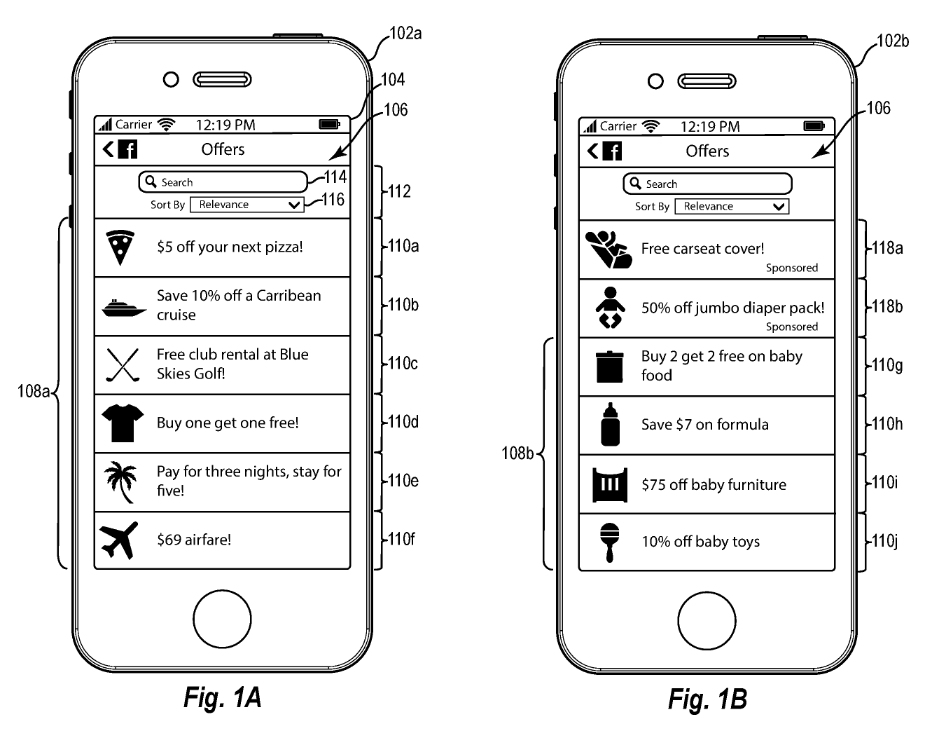

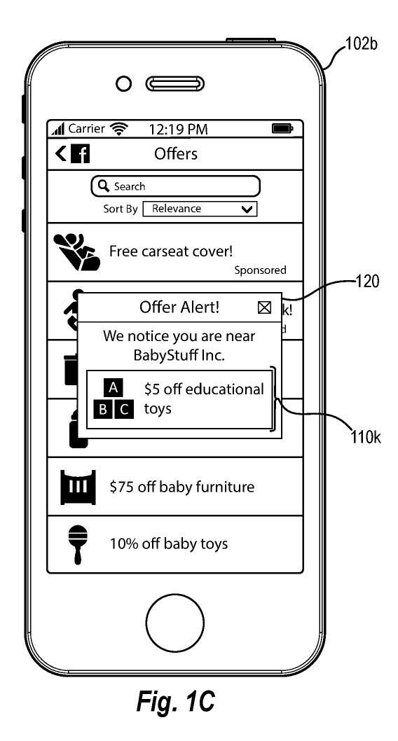

As will be described in more detail below, the components of the offer management system can provide, along and/or in combination with the other components, one or more graphical user interfaces (“GUIs”). In particular, social networking system application installed on a client-computing device can display one or more GUIs generated by the social networking system. The social networking system application can allow a user to interact with a collection of display elements for a variety of purposes. FIGS. 1A-1C and the description that follows illustrate various example embodiments of the GUIs and features that are in accordance with general principles as described above.

For example, FIG. 1A illustrates a client-computing device 102a that may implement one or more of the components or features of an example offer management system. As shown, the client-computing device 102a is a handheld device, such as a mobile phone device (e.g., a smartphone). As used herein, the term “handheld device” refers to a device sized and configured to be held/operated in a single hand of a user. In additional or alternative examples, however, any other suitable computing device, such as, but not limited to, a tablet device, larger wireless device, laptop or desktop computer, personal digital assistant device, and/or any other suitable computing device can perform one or more of the processes and/or operations described herein.

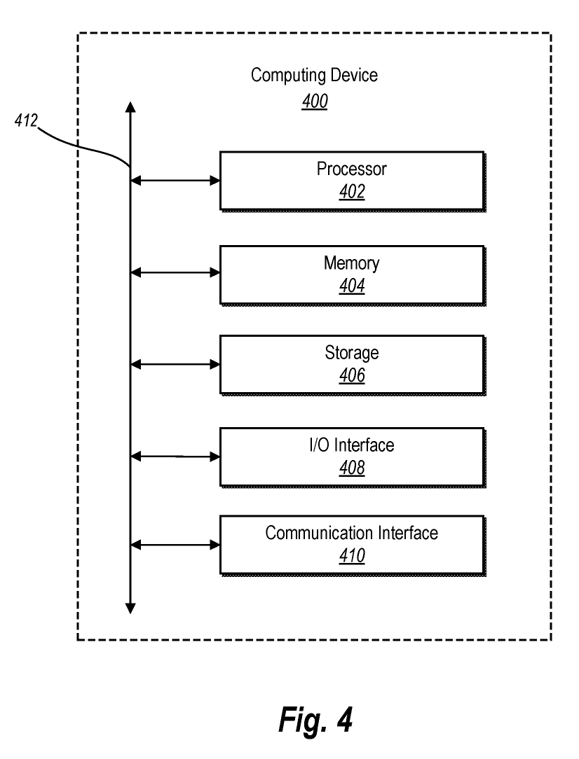

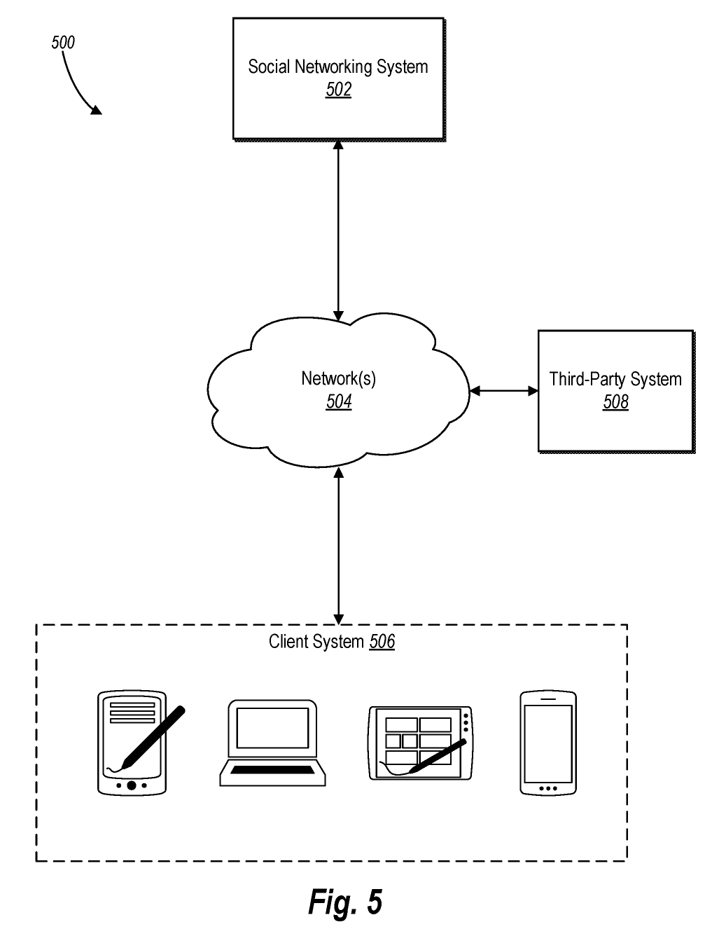

As illustrated in FIG. 1A, the client-computing device 102a includes a touch screen display 104 that can display graphical user interfaces and by way of which user input may be received and/or detected. As used herein, a “touch screen display” refers to the display of a touch screen device. In one or more embodiments, a touch screen device may be the client-computing device 102a with at least one surface upon which a user may perform touch gestures (e.g., a laptop, a tablet computer, a personal digital assistant, a media player, a mobile phone, etc.). Additionally, or alternatively, the client-computing device 102a may include any other suitable input device, such as a touch pad or those described below with reference to FIG. 4.

In FIG. 1A, the touch screen display 104 of the client-computing device 102a display an offers GUI 106 provided by the social networking system application installed thereon. As mentioned above, the social networking system application enables the user of the client-computing device 102a to engage in social networking system activities (e.g., scrolling through a newsfeed, viewing and composing electronic messages, etc.). Also as described above, in response to the user selecting an option to view one or more offers, the offer management system generates the offers GUI 106.

As shown in FIG. 1A, in one or more embodiments, the offers GUI 106 includes an offers listing 108a. For example, the offers listing 108a includes offers 110a-110f. As described above, each offer 110a-110f is an interactive object that is associated with an offer stored by the social networking system.

As discussed above, the offer management system identifies each of the offers associated with the offers 110a-110f because each offer is relevant to the user of the client-computing device 102a. For example, after monitoring and analyzing the user's social networking system activity and profile information, the offer management system can determine that the user of the client-computing device 102a is male, in his mid-20s, single, employed as a computer programmer, and likes to travel. Accordingly, the offer management system identifies offers that apply to the user, such as those associated with the offers 110a-110f. For instance, the offer management system identifies travel offers (e.g., associated with the offers 110b, 110e, and 110f) in response to an analysis of the user's electronic messages discussing travel plans, the user sharing travel articles, the user liking other social networking system user's travel posts, and the user's previous and regular photograph uploads featuring vacation locations. Additionally, the offer management system identifies a pizza offer (e.g., associated with the offer 110a) in response to an analysis of the user's electronic messages between a group of friends discussing weekend plans for a house party. Similarly, the offer management system identifies the golf and clothing offers (e.g., associated with the offers 110c and 110d) in response to an analysis of the user's demographic information indicating the user's gender, age, and hobbies.

As shown in FIG. 1A, the offer management system also ranks the offers 110a-110f. In one or more embodiments, the offer management system ranks offers by calculating a weighted affinity score for each offer that represents a relationship between the user of the client-computing device 102a and the offer. For example, the offer management system can analyze a wealth of user information (e.g., related to commercial activities and/or related to non-commercial activities) in view of information associated with the offer in order to calculate an affinity score for the user relative to the offer that indicates a likelihood that the user of the client-computing device 102a will be interested in the offer. Thus, the offer management system can rank the offers 110a-110f from highest affinity score to lowest affinity score, such that the first offer in the list (e.g., offer 110a) is the offer with the highest affinity score relative to the user.

To calculate a weighted affinity score for the offer associated with the offer 110a, as shown in FIG. 1A, the offer management system assigns a weighted value to data in common between the user and the structured offer object. For example, the offer management system may determine that the user of the client-computing device 102a enjoys playing video games and eating pizza on weekends. Accordingly, the offer management system may calculate an affinity score for the offer 110a that indicates that the user of the client-computing device 102a will likely use the offer because the offer is for pizza from a restaurant near where the user lives. In at least one embodiment, the offer management system may further weight the calculated affinity score based on a determination that it is Friday afternoon, and the user will likely want to use the offer 110a soon.

After calculating a weighted affinity score for each offer associated with the offers 110a-110f, the offer management system ranks the offers 110a-110f and generates the offers listing 108a. As shown in FIG. 1A, in one or more embodiments, the offer management system generates the offers listing 108a such that the highest ranked offer (e.g., the offer 110a) is at the top of the offers listing 108a. It follows that the offer management system includes the offers 110b-110f in descending rank order within the offers listing 108a.

As shown in FIG. 1A, the offers GUI 106 further includes a management header 112. In one or more embodiments, the offer management system enables the user of the client-computing device 102a to search and sort the offers listing 108a. For example, in response to the user entering search terms in the search control 114, the offer management system can identify offers represented within the offers listing 108a that respond to the user's search. In at least one embodiment, the offer management system can search the offers listing 108a based on the text of an offer, the multimedia associated with an offer, and the metadata associated with the offer. Furthermore, the offer management system can perform searches based on compound search terms, natural language strings, Boolean operators, keywords, and so forth.

Also, while the offer management system initially orders the offers listing 108a according to each offer's calculated affinity score (e.g., by each offer's “relevance”), the offer management system can order the offers listing 108a in other ways. For example, the offer management system can order the offers within the offers listing 108a by expiration date, by offer category, by merchant, by estimated value, and so forth. In one or more embodiments, the offer management system defaults the sorting type for the offers listing 108a to “relevance.”

As mentioned above, in one or more embodiments, the offer management system can include sponsored offers within a generated offers GUI. For example, as shown in FIG. 1B, the offer management system includes the sponsored offers 118a, 118b in the offers GUI 106 on the client-computing device 102b. To illustrate, the offer management system monitors and analyzes profile information and social networking system activity of the user of the client-computing device 102b to determine the user is female, in her late 20s, and pregnant with her first child. Based on this determination, the offer management system identifies the offers associated with the offers 110g-110k.

Additionally, as mentioned above, merchants and other companies may pay the social networking system to provide certain offers to a given percentage of social networking system users who match various parameters specified by the merchant and/or company. As shown in FIG. 1B, the merchants associated with the sponsored offers 118a, 118b have previously arranged with the social networking system to provide the offers represented by the sponsored offers 118a, 118b to social networking system users who are within a few months of having his or her first baby.

In at least one embodiment, as mentioned above, the offer management system provides one or more additional offers based on the user's selection of a first offer. For example, as shown in FIG. 1B, the offer management system may have provided the offers 110h and 110i in response to the user selecting the offer 110g. In that case, the offer management system does not include the offers 110h and 110i based on a ranked affinity score.

As discussed above, the offer management system can provide alerts for offers that are within a geographic proximity to the user's current locations. For example, as shown in FIG. 1C, the offer management system provides the offer alert 120 in response to determining that the offer represented therein applies to the user of the client-computing device 102b and that the user of the client-computing device 102b is within a geographic proximity to a location where the offer can be used or redeemed. In one or more embodiments, the offer management system only provides offer alerts to social networking system users who have explicitly opted in to receiving this service. As shown in FIG. 1C, the offer alert 120 includes a message identifying the location where the offer can be redeemed as well as the offer 1101.

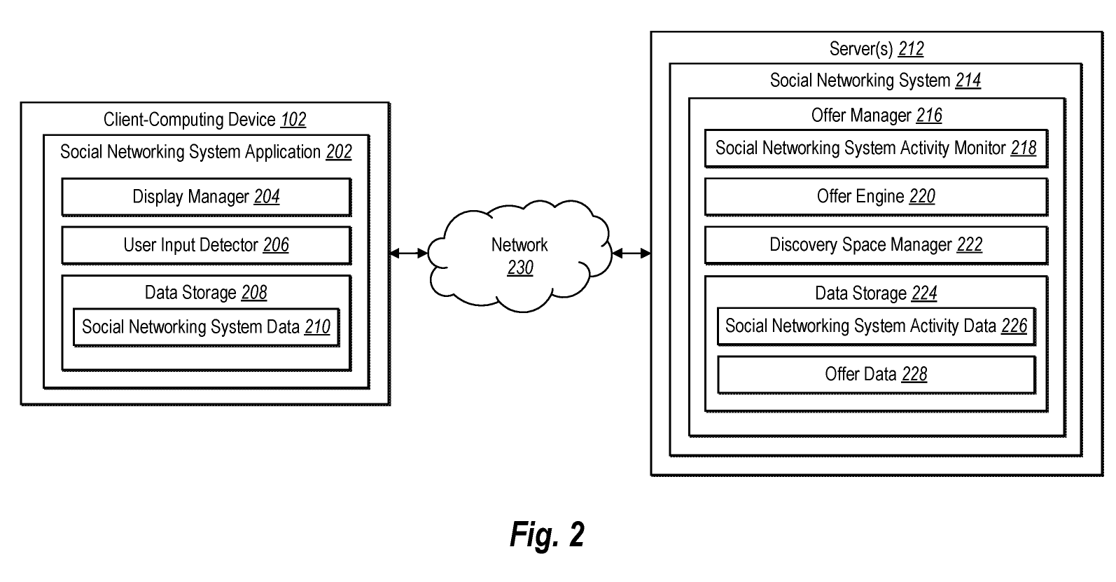

FIG. 2 illustrates a schematic diagram illustrating an example embodiment of the offer management system. As shown in FIG. 2, the offer management system includes various components for performing the processes and features described herein. For example, as shown in FIG. 2, the offer management system includes but is not limited to, the client-computing device 102 (e.g., the client-computing device 102a, 102b) and the server 212. In one or more embodiments, the client-computing device 102 includes a social networking system application 202, which includes a display manager 204, a user input detector 206, and a data storage 208 storing social networking system data 210. Additionally, the server 212 hosts the social networking system 214. In one or more embodiments, the social networking system 214 hosts the offer manager 216 including a social networking system activity monitor 218, an offer engine 220, a discovery space manager 222, and a data storage 224 storing social networking system activity data 226 and offer data 228.

Each of the components 204-208 of the social networking system application 202 and the components 216-224 of the social networking system 214 can be implemented using a computing device including at least one processor executing instructions that cause the offer management system to perform the processes described herein. In some embodiments, some or all of the components described herein can be implemented by the server 212, or across multiple server devices. Furthermore, in at least one embodiment, the processes described herein can be performed entirely by the server 212, or by a combination of servers and client-computing devices. Additionally or alternatively, the components 204-224 can comprise a combination of computer-executable instructions and hardware.

In one or more embodiments, the social networking system application 202 is a native application installed on the client-computing device 102. For example, the social networking system application 202 can be a mobile application that installs and runs on a mobile device, such as a smart phone or a tablet computer. Alternatively, the social networking system application 202 can be a desktop application, widget, or other form of a native computer program. Furthermore, the social networking system application 202 may be a remote application accessed by the client-computing device 102. For example, the social networking system application 202 may be a web application that is executed within a web browser of the client-computing device 102.

As mentioned above, and as shown in FIG. 2, the social networking system application 202 includes a display manager 204. The display manager 204 provides, manages, and/or controls a graphical user interface that allows a social networking system user to interact with features of the social networking system 214. For example, the display manager 204 provides a graphical user interface that facilitates the display of the social networking system user's newsfeed (a feed of content tailored for the user's consumption based on the user's social connections and interests). Similarly, the display manager 204 provides a graphical user interface that displays an offers GUI 106, as illustrated in FIGS. 1A-1C.

More specifically, the display manager 204 facilitates and manages the display of a graphical user interface (e.g., by way of the touch screen display 104 associated with the client-computing device 102a, 102b, as shown in FIGS. 1A-1C). For example, the display manager 204 may compose the graphical user interface of a plurality of graphical components, objects, and/or elements that allow a user to engage in social networking system activities. More particularly, the display manager 204 may direct the client-computing device 102 to display a group of graphical components, objects, and/or elements that enable a user to view electronic messages, communication threads, newsfeeds, offers, and so forth.

In addition, the display manager 204 directs the client-computing device 102 to display one or more graphical objects, controls, or elements that facilitate user input for entering text, clicking, or performing touch gestures. To illustrate, the display manager 204 provides a graphical user interface that allows a user to provide user input to the social networking system application 202. For example, the display manager 204 provides one or more user interfaces that allow a user to input one or more types of content (e.g., text, images, links) into a social networking system post or electronic message.

The display manager 204 also facilitates the input of text or other data to be included in a social networking system post or electronic message. For example, the display manager 204 provides a user interface that includes a touch display keyboard. A user can interact with the touch display keyboard using one or more touch gestures to input text to be included in a social networking system post or electronic message. For example, a user can use the touch display keyboard to compose a message. In addition to text, the graphical user interface including the touch display keyboard can facilitate the input of various other characters, symbols, icons, or other information.

Furthermore, the display manager 204 is capable of transitioning between two or more graphical user interfaces. For example, in one embodiment, the display manager 204 provides a newsfeed to a social networking system user containing one or more social networking system posts from co-users associated with the user via the social networking system. Later, in response to detected input from the user, the display manager 204 transitions to a second graphical user interface that includes the offers listing 108a, 108b, as illustrated in FIGS. 1A-1C.

As further illustrated in FIG. 2, the social networking system application 202 includes a user input detector 206. In one or more embodiments, the user input detector 206 detects, receives, and/or facilitates user input in any suitable manner. In some examples, the user input detector 206 detects one or more user interactions with respect to the user interface. As referred to herein, a “user interaction” means a single interaction, or combination of interactions, received from a user by way of one or more input devices.

For example, the user input detector 206 detects a user interaction from a keyboard, mouse, touch page, touch screen, and/or any other input device. In the event the client-computing device 102 includes a touch screen, the user input detector 206 detects one or more touch gestures (e.g., swipe gestures, tap gestures, pinch gestures, reverse pinch gestures) from a user that forms a user interaction. In some examples, a user can provide the touch gestures in relation to and/or directed at one or more graphical objects or graphical elements of a user interface.

The user input detector 206 may additionally, or alternatively, receive data representative of a user interaction. For example, the user input detector 206 may receive one or more user configurable parameters from a user, one or more commands from the user, and/or any other suitable user input. The user input detector 206 may receive input data from one or more components of the social networking system 214, or from one or more remote locations.

The social networking system application 202 performs one or more functions in response to the user input detector 206 detecting user input and/or receiving other data. Generally, a user can control, navigate within, and otherwise use the social networking system application 202 by providing one or more user inputs that the user input detector 206 can detect. For example, in response to the user input detector 206 detecting user input, one or more components of the social networking system application 202 allow a user to select a recipient for an electronic message, compose an electronic message, select content to include in an electronic message, and/or send an electronic message to the recipient. Additionally, in response to the user input detector 206 detecting user input, one or more components of the social networking system application 202 allow a user to navigate through one or more user interfaces to review and respond to received electronic messages, etc.

As shown in FIG. 2, and as mentioned above, the social networking system application 202 also includes the data storage 208. The data storage 208 includes social networking system data 210. In one or more embodiments, the social networking system data 210 is representative of social networking system activity and other information associated with social networking system users, such as described herein.

Also as shown in FIG. 2, and as mentioned above, the server 212 hosts the social networking system 214. In general, the social networking system 214 allows users to access content and information associated with the multiple co-users. The social networking system 214 provides social networking system posts and electronic messages (whether text or otherwise) to users of the social networking system 214 (e.g., by way of profile pages, newsfeeds, communication threads, timelines, and/or a “wall”). For example, one or more embodiments provide a user with a social networking system newsfeed and electronic messages from one or more co-users associated with the user (e.g., friends of the user) via the social networking system 214.

In one or more embodiments, the user scrolls through the social networking system newsfeed in order to view recent social networking system posts submitted by co-users associated with the user via the social networking system 214. In some embodiments, the social networking system 214 organizes content chronologically in a user's social networking system newsfeed. In additional embodiments, the social networking system 214 organizes the content geographically, by interest groups, according to a relationship coefficient between the user and a co-user, etc.

The social networking system 214 also enables the user to engage in all other types of social networking system activity. For example, the social networking system 214 enables a social networking system user to scroll through newsfeeds, click on posts and hyperlinks, view and save offers, compose and submit electronic messages, comments, and posts, interact with content, and so forth. As mentioned above, an offer can include structured data. For example, structured data can include metadata associated with node and edge information related to an offer, information related to the offer's author, information related to a particular item featured in the offer, and interaction information related to the offer within the social networking system 214. To illustrate, structured data for an offer can include formatting information, the offer author's name and location, content of the offer, expiration information related to the offer, or any other specific types of information/data associated with the offer. The structured data may also include various multimedia content such as images (e.g., digital pictures, digital map images), video, audio, etc. Using this structured data, the social networking system 214 can facilitate the insertion of offers within a newsfeed, a listing, or elsewhere.

As shown in FIG. 2, and as mentioned above, the social networking system 214 includes the offer manager 216. In one or more embodiments, the offer manager 216 identifies offers that are relevant to a social networking system user (or, for which, the social networking system user qualifies) and provides those identified offers to the social networking system user. Additionally, the offer manager 216 alerts the user to offers that are applicable to the user's current geographic location. Further, the offer manager 216 identifies additional offers that may be of interest to the user based on the user's offer selection history.

As shown in FIG. 2, the offer manager 216 includes the social networking system activity monitor 218. In one or more embodiments, the social networking system activity monitor 218 monitors and analyzes a user's social networking system activity in order to determine one or more characteristics of the user. For example, the social networking system activity monitor 218 monitors a user's social networking system activity by communicating with the social networking system 214 to identify every instance of the user's activity within the social networking system 214. The user interacts with the social networking system 214 by clicking hyperlinks, tapping on display elements, scrolling through newsfeeds, pausing while scrolling through newsfeeds, mousing over display elements, performing one or more touch gestures in combination with a display element, entering text, uploading multimedia, and otherwise navigating through and interacting with the graphical user interfaces provided by the social networking system 214.

Additionally, the social networking system activity monitor 218 identifies profile information associated with the social networking system user. For example, the social networking system 214 maintains a profile for each social networking system user. In one or more embodiments, a user's profile includes the user's demographic information (e.g., age, gender, location, etc.), educational information, occupational information, relationship information, interest information, and so forth. Additionally, profile information can include information related to the user's social networking system “friends” (e.g., information on how the user's friends interact and engage with the social networking system 214).

Once the social networking system activity monitor 218 identifies the user's social networking system activity information and profile information, the social networking system activity monitor 218 analyzes the identified information in order to determine one or more characteristics related to the user. In one or more embodiments, the social networking system activity monitor 218 utilizes optical character recognition, textual analysis, image analysis, video analysis, and so forth to identify topics and keywords from social networking system objects (e.g., social networking system posts, electronic messages, multimedia uploads, and so forth) with which the user has interacted. The social networking system activity monitor 218 then utilizes neural networks and/or machine learning in connection with the identified topics and keywords to determine one or more characteristics of the social networking system user.

To illustrate, in response to identifying that the user frequently likes photographs, videos, and posts that focus on exotic locations, the social networking system activity monitor 218 can determine that the user is interested in travel. In another example, in response to textual analysis of electronic messages exchanged between the user and other co-users that include words such as “due date,” “registry,” “nursery,” and “prenatal,” the social networking system activity monitor 218 can determine that the user is likely having a baby. In one or more embodiments, the social networking system activity monitor 218 utilizes machine learning (e.g., a trained neural network) to make these determinations regarding one or more characteristics of the social networking system user.

As shown in FIG. 2, the offer manager 216 also includes an offer engine 220. In one or more embodiments, the offer engine 220 identifies one or more available offers that apply to a social networking system user. As mentioned above, when a merchant or company collaborates with the social networking system 214 to provide an offer to social networking system users, the social networking system 214 creates a structured object for the offer that includes text, multimedia, metadata, and so forth. In one or more embodiments, the offer engine 220 identifies an offer that applies to the social networking system user by attempting to match information or characteristics within the offer's structured object to characteristics of the user. As discussed above, in at least one embodiment, the offer's structured object is a node within the social graph.

To illustrate, as discussed above, the social networking system activity monitor 218 may determine that a user is interested in travel based on the user's social networking system activities. Accordingly, in one or more embodiments, the offer engine 220 can identify all offers currently available within the social networking system 214 that are related to travel. In other words, in one or more embodiments, the offer engine 220 identifies all offers that apply to a particular user based on a keyword search. In at least one embodiment, the offer engine 220 additionally identifies these applicable offers by analyzing the metadata, text, multimedia, etc. associated with each offer. For example, an offer may include metadata comprising a set of keywords such as “travel,” “vacation,” “adventure,” etc. In order to identify all offers that apply to the social networking system user, the offer engine 220 repeats this process with all available offers within the social networking system 214. In alternative embodiments, the offer engine 220 may only repeat this process until it has identified a maximum number of offers (e.g., the offer engine 220 stops identifying offers after it has identified ten offers that apply to the social networking system user).

In at least one embodiment, the offer engine 220 identifies offers based on product concurrence. For example, in one embodiment, retailer purchase histories show that two or more products are frequently purchased as part of concurrent transactions. To illustrate, a retailer may have purchase information that indicates that when shoppers purchase baby diapers, they frequently also baby diaper wipes in the same transaction. Accordingly, in one or more embodiments, in response to identifying a baby diaper offer that applies to a social networking system user, the offer engine 220 can also determine that a concurrent offer for baby diaper wipes also applies to the social networking system user. In one or more embodiments, product concurrencies or similarities are based on retailer-providing information (e.g., purchase histories, etc.), social networking system activity history, browser history, and so forth.

Additionally, in at least one embodiment, the offer engine 220 identifies offers based on the social networking system user's loyalty memberships. For example, in one embodiment, the user may apply one or more loyalty memberships (e.g., grocery store loyalty memberships, department store loyalty memberships, restaurant loyalty memberships, etc.) associated with his or her social networking system account. Thus, the offer engine 220 can determine that the user is member of a particular loyalty club, and identify offers that are specific to users who are members of that particular loyalty club.

Furthermore, in at least one embodiment, the offer engine 220 can prompt a social networking system user to become a member of a loyalty club in order to use a particular offer. For example, the offer engine 220 can determine that a user is not a member of a particular loyalty club for which an offer is available. Thus, in order to apply the offer with the user's social networking system account, the offer engine 220 can prompt (e.g., provide a hyperlink, a web form, an interface, etc.) the user to join the loyalty club, using the offer as incentive. In response to the user joining the loyalty club, the offer engine 220 can apply the desired offer with the user's social networking system account.

In one or more embodiments, once the offer engine 220 has identified a pool of offers that apply to a social networking system user, the offer engine 220 calculates an affinity score for each offer. An offer's calculated affinity score represents a likely level of engagement between the social networking system user and the offer. In at least one embodiment, the offer engine 220 calculates an affinity score for an offer by identifying a plurality of characteristics associated with the offer, and then attempting to match the offer's characteristics to the characteristics identified for the social networking system user. Furthermore, the offer engine 220 adds extra weight to characteristics of the offer that match dominant characteristics associated with the social networking system user. Additionally, in at least one embodiment, the offer engine 220 adds extra weight to concurrences between offers, as described above.

To illustrate, the offer engine 220 can use various types of electronic analysis on the contents of the offer's structured object to determine that an offer is associated with characteristics including “pregnancy class,” “prenatal care,” “labor exercises,” and “every Wednesday at 7 pm.” The offer engine 220 can then identify characteristics associated with a social networking system user (e.g., based on the user's social networking system activity) including, “pregnant,” “maternity care,” “age 26,” and “female.” In at least one embodiment, the offer engine 220 then utilizes machine learning to identify matches between these characteristics.

The offer engine 220 not only makes direct textual matches, but can also match characteristics based on topic or sentiment. For example, the user's characteristics “pregnant” and “maternity care” match the over-arching topic or sentiment of the characteristics associated with the offer. Thus, the offer engine 220 can determine that a match exists between the offer and the social networking system user. In other words, the offer engine 220 utilizes machine learning to determine that the offer is related to pregnancy classes and that the user is interested in taking a pregnancy class because she is likely pregnant. Furthermore, the offer engine can add extra weight to the offer characteristic “every Wednesday at 7 pm” in response to determining that the user is available during that time (e.g., in response to analysis of calendar information associated with the user).

In at least one embodiment, the offer engine 220 adds further weights to matches between user and offer characteristics based on targeting information provided by a retailer, advertiser, etc. For example, in one embodiment, a retailer may wish to provide an offer to social networking system users who are associated with various characteristics (e.g., users who are female, aged 20-35, and living in the Pacific Northwest). Accordingly, because of these targeted characteristics specified by the entity providing the offer, the offer engine 220 can add extra weight to matches between the user and the offer that include these targeted characteristics.

Furthermore, in at least one embodiment, the offer engine 220 calculates the affinity score based on a social graph maintained by the social networking system 214. For example, in one or more embodiments, as will be described further below, the social graph maintained by the social networking system 214 includes nodes connected by edges. In at least one embodiment, the social graph includes at least one node associated with the user of the client-computing device 102, wherein the at least one node is associated with the user's social networking system activity information. Furthermore, in at least one embodiment, the social graph includes at least one node associated with an offer, and one or more edges connecting the user's node with the offer's node. Thus, the offer engine 220 can add a value to an affinity score between the user and the offer based on the number and weight of the one or more edges connecting the user's node with the offer's node within the social graph.

Once the offer engine 220 has calculated an affinity score for each identified offer that applies to a social networking system user, the offer engine 220 next ranks the offers based on their affinity scores. For example, in at least one embodiment, an offer's affinity score is a numerical value that increases in a manner that is directly proportional to the affinity level between the user and the offer. Thus, the higher an offer's affinity score, the more likely it is that the user will be interested in the offer. Accordingly, in at least one embodiment, the offer engine 220 ranks the identified offers such that the offer with the highest affinity score is ranked first, and the offer with the lowest affinity score is ranked last.

As mentioned above, a social networking system user's previously selected offers can influence the affinity score of future offers. To illustrate, a user may have selected offers within the last two weeks that include “Save 10% Off Your Next Flight,” and “Stay 3 Nights Get A 4^{th} Night Free!” From these previous selections, the offer engine 220 can utilize machine learning to determine that not only is the user interested in travel, but that the user is possibly taking a trip soon. In one or more embodiments, and based on this determination, the offer engine 220 will add extra weight to identified travel offers when calculating an affinity score for those offers.

Also mentioned above, in certain embodiments, the offer engine 220 can add extra weight to offers that are applicable to the user's present location. For example, a social networking system user may be walking through a shopping mall that includes a particular women's clothing store. In one or more embodiments, the offer engine 220 determines the user's location by accessing GPS information, WIFI information, etc. associated with the user's personal computing device (e.g., the user's smartphone). At this point, the offer manager 216 may have already determined that an offer for the women's clothing store applies to the user based on the user's social networking system activity, but the offer engine 220 may have not calculated a very high affinity score for the offer in light of other factors (e.g., the user may have sent an electronic message to a friend complaining about her lack of funds that month). However, in light of the user's current location proximate to the women's clothing store, the offer manager 216 can recalculate the offer's affinity score with added weight.

In at least one embodiment, the offer engine 220 can determine that the offer should be pushed to the user in the form of an alert or pop-up based on the user's current geographic location. For example, if the offer engine 220 recalculates the offer's affinity score past a given threshold (e.g., in response to determining that the user is approaching the store), the offer engine 220 can mark the offer as urgent and/or suitable for a push alert to the user via the user's personal computing device. In at least one embodiment, the offer engine 220 only marks offers for push alerts or pop-ups in response to the user opting in to the service. For example, the social networking system user may select an option within his or her social networking system profile that enables the offer manager 216 to generate and provide pop-up windows including offers when the user is close to a location associated with the offer.

As mentioned above, and as illustrated in FIG. 2, the offer manager 216 also includes a discovery space manager 222. In one or more embodiments, the discovery space manager 222 generates a display of a social networking system user's ranked listing of offers (e.g., the user's “Discovery Space”). For example, in at least one embodiment, in response to the offer engine 220 ranking a collection of offers that apply to a social networking system user, the discovery space manager 222 can generate a graphical user interface that includes each ranked offer's structural offer displayed in order of its rank.

Furthermore, as mentioned above, the offer manager 216 can provide push alerts or pop-ups to a user based on the user's current geographic location. Accordingly, in one or more embodiments, the discovery space manager 222 generates the push alert or pop-up window for display to the social networking system user. For example, the discovery space manager 222 can generate a pop-up window that includes text (e.g., “You are within 100 feet of Baby World! You might be interested in the following offer . . . ”), along with content and information associated with the applicable offer.

Additionally, in one or more embodiments, the offer manager 216 can collaborate with merchants and companies to provide sponsored offers to social networking system users who match a profile defined by the merchant or company. Accordingly, in at least one embodiment, the discovery space manager 222 inserts structured objects associated with sponsored offers identified by the offer manager 216 into a social networking system user's discovery space. For example, the discovery space manager 222 may insert all sponsored offers into the top of the user's listing of ranked offers. Alternatively, the discovery space manager 222 may intersperse identified offers evenly within the user's listing of ranked offers.

As shown in FIG. 2, and as mentioned above, the offer manager 216 also includes the data storage 224. The data storage 224 includes social networking system activity data 226 and offer data 228. In one or more embodiments, the social networking system activity data 226 is representative of social networking system activity information, such as described herein. Furthermore, in one or more embodiments, the offer data 228 is representative of offer information, such as described herein.

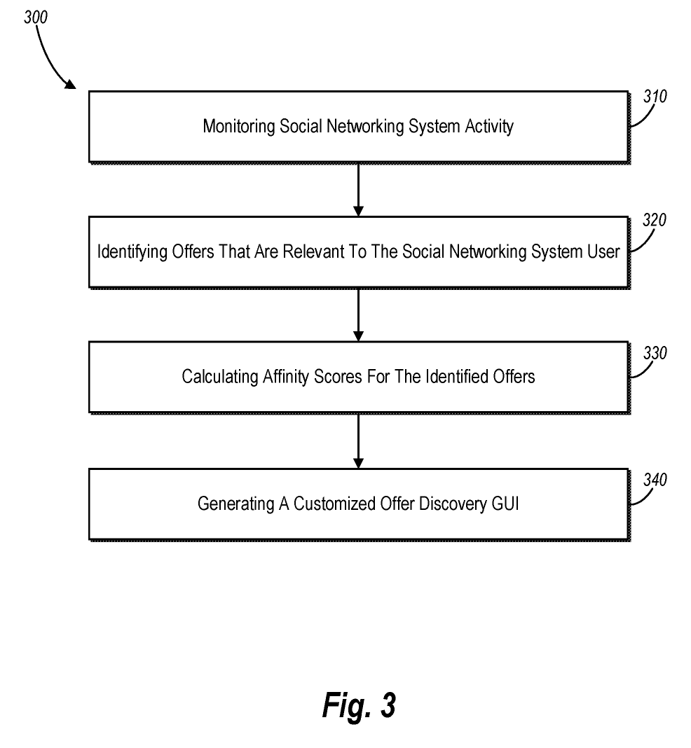

FIGS. 1 and 2, the corresponding text and examples, provide a number of different methods, systems, and devices for identifying and providing offers to social networking system users. In addition to the foregoing, embodiments can also be described in terms of flowcharts comprising acts and steps in a method for accomplishing a particular result. For example, FIG. 3 may be performed with less or more steps/acts or the steps/acts may be performed in differing orders. Additionally, the steps/acts described herein may be repeated or performed in parallel with one another or in parallel with different instances of the same or similar steps/acts.

FIG. 3 illustrates a flowchart of one example method 300 of identifying and providing offers to social networking system users. The method 300 includes an act 310 of monitoring social networking system activity. In particular, the act 310 can involve monitoring, by at least one processor of a social networking system, social networking system activity associated with a social networking system user represented by a user node within a social graph of the social networking system comprising a plurality of nodes connected by a plurality of edges, and wherein the user node comprises data representative of the monitored social networking activity. For example, monitoring social networking system activity associated with a social networking system user can include identifying the data representative of the monitored social networking activity within the user node within the social graph; identifying one or more edges of the plurality of edges that connect the user node to one or more co-user nodes; and identifying data within the one or more co-user nodes for data representative of monitored social networking activity associated with one or more co-users of the social networking system user.

Furthermore, the method 300 includes an act 320 of identifying offers that are relevant to the social networking system user. In particular, the act 320 can involve identifying, by the at least one processor and based at least in part on the monitored social networking system activity, a plurality of offers that are relevant to the social networking system user, wherein each of the plurality of offers is represented by an offer node within the social graph. For example, in at least one embodiment, identifying a plurality of offers that are relevant to the social networking system user is further based on the monitored social networking activity associated with one or more co-users of the social networking system user. Additionally or alternatively, in at least one embodiment, identifying a plurality of offers that are relevant to the social networking system user further includes identifying offers that correspond with one or more of: the social networking system user's demographic, the social networking system user's geographic location, the social networking system user's offer use history, and the social networking system user's profile information.

Additionally, the method 300 includes an act 330 of calculating affinity scores for the identified offers. In particular, the act 330 can involve calculating, by the at least one processor and based on the social graph, an affinity score for each of the plurality of identified offers with respect to the social networking system user. For example, in at least one embodiment, calculating the affinity score for each of the plurality of identified offers with respect to the user includes, for each identified offer: identifying the user node, wherein the user node further comprises one or more characteristics specific to the social networking system user; identifying an offer node representing the identified offer, wherein the offer node representing the identified offer comprises one or more characteristics specific to the offer; determining one or more corresponding characteristics between the user node and the offer node; and adding a weighted value to the affinity score for each of the identified one or more corresponding characteristics between the user node and the offer node.

The method 300 also includes an act 340 of generating a customized offer discovery GUI. In particular, the act 340 can involve generating, by the at least one processor, a customized offer discovery graphical user interface accessible by the social networking system user via the social networking system, the customized offer discovery graphical user interface comprising the plurality of identified offers organized in accordance with the calculated affinity scores. For example, in at least one embodiment, generating the customized offer discovery graphical user interface includes: ranking the plurality of offers based on the calculated affinity score for each of the plurality of identified offers; wherein generating the customized offer discovery graphical user interface further comprises listing the ranked plurality of offers such that a top-ranked offer is listed first.

In one or more embodiments, the method 300 includes the steps of identifying a current geographic location of the social networking system user, identifying at least one offer that is relevant to the current geographic location of the social networking system user, generating an alert comprising the identified at least one offer, presenting the generated alert to the social networking system user while the social networking system user is within a geographic radius associated with the at least one offer. Furthermore, in at least one embodiment, the method 300 includes the step of identifying at least one sponsored offer that applies to the social networking system users, wherein generating the graphical user interface further comprises adding the at least one sponsored offer to the graphical user interface.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 4 illustrates a block diagram of exemplary computing device 400 that may be configured to perform one or more of the processes described above. One will appreciate that one or more computing devices such as the computing device 400 may implement the offer management system. As shown by FIG. 4, the computing device 400 can comprise a processor 402, a memory 404, a storage device 406, an I/O interface 408, and a communication interface 410, which may be communicatively coupled by way of a communication infrastructure 412. While an exemplary computing device 400 is shown in FIG. 4, the components illustrated in FIG. 4 are not intended to be limiting. Additional or alternative components may be used in other embodiments. Furthermore, in certain embodiments, the computing device 400 can include fewer components than those shown in FIG. 4. Components of the computing device 400 shown in FIG. 4 will now be described in additional detail.

In one or more embodiments, the processor 402 includes hardware for executing instructions, such as those making up a computer program. As an example and not by way of limitation, to execute instructions, the processor 402 may retrieve (or fetch) the instructions from an internal register, an internal cache, the memory 404, or the storage device 406 and decode and execute them. In one or more embodiments, the processor 402 may include one or more internal caches for data, instructions, or addresses. As an example and not by way of limitation, the processor 402 may include one or more instruction caches, one or more data caches, and one or more translation lookaside buffers (TLBs). Instructions in the instruction caches may be copies of instructions in the memory 404 or the storage device 406.

The memory 404 may be used for storing data, metadata, and programs for execution by the processor(s). The memory 404 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 404 may be internal or distributed memory.

The storage device 406 includes storage for storing data or instructions. As an example and not by way of limitation, storage device 406 can comprise a non-transitory storage medium described above. The storage device 406 may include a hard disk drive (HDD), a floppy disk drive, flash memory, an optical disc, a magneto-optical disc, magnetic tape, or a Universal Serial Bus (USB) drive or a combination of two or more of these. The storage device 406 may include removable or non-removable (or fixed) media, where appropriate. The storage device 406 may be internal or external to the computing device 400. In one or more embodiments, the storage device 406 is non-volatile, solid-state memory. In other embodiments, the storage device 406 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 408 allows a user to provide input to, receive output from, and otherwise transfer data to and receive data from computing device 400. The I/O interface 408 may include a mouse, a keypad or a keyboard, a touch screen, a camera, an optical scanner, network interface, modem, other known I/O devices or a combination of such I/O interfaces. The I/O interface 408 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 408 is configured to provide graphical data to a display for presentation to a user. The graphical data may be representative of one or more graphical user interfaces and/or any other graphical content as may serve a particular implementation.

The communication interface 410 can include hardware, software, or both. In any event, the communication interface 410 can provide one or more interfaces for communication (such as, for example, packet-based communication) between the computing device 400 and one or more other computing devices or networks. As an example and not by way of limitation, the communication interface 410 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 410 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 410 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 410 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 412 may include hardware, software, or both that couples components of the computing device 400 to each other. As an example and not by way of limitation, the communication infrastructure 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the offer management system can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g., posts, photo-sharing, event organization, messaging, games, or advertisements) to facilitate social interaction between or among users.

The social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

FIG. 5 illustrates an example network environment 500 of a social networking system. Network environment 500 includes a client device 506, a social networking system 502, and a third-party system 508 connected to each other by a network 504. Although FIG. 5 illustrates a particular arrangement of client device 506, social networking system 502, third-party system 508, and network 504, this disclosure contemplates any suitable arrangement of client device 506, social networking system 502, third-party system 508, and network 504. As an example and not by way of limitation, two or more of client device 506, social networking system 502, and third-party system 508 may be connected to each other directly, bypassing network 504. As another example, two or more of client device 506, social networking system 502, and third-party system 508 may be physically or logically co-located with each other in whole or in part. Moreover, although FIG. 5 illustrates a particular number of client devices 506, social networking systems 502, third-party systems 508, and networks 504, this disclosure contemplates any suitable number of client devices 506, social networking systems 502, third-party systems 508, and networks 504. As an example and not by way of limitation, network environment 500 may include multiple client device 506, social networking systems 502, third-party systems 508, and networks 504.

This disclosure contemplates any suitable network 504. As an example and not by way of limitation, one or more portions of network 504 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 504 may include one or more networks 504.

Links may connect client device 506, social networking system 502, and third-party system 508 to communication network 504 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 500. One or more first links may differ in one or more respects from one or more second links.

In particular embodiments, client device 506 may be an electronic device including hardware, software, or embedded logic components or a combination of two or more such components and capable of carrying out the appropriate functionalities implemented or supported by client device 506. As an example and not by way of limitation, a client device 506 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 506. A client device 506 may enable a network user at client device 506 to access network 504. A client device 506 may enable its user to communicate with other users at other client devices 506.

In particular embodiments, client device 506 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 506 may enter a Uniform Resource Locator (URL) or other address directing the web browser to a particular server (such as server, or a server associated with a third-party system 508), and the web browser may generate a Hyper Text Transfer Protocol (HTTP) request and communicate the HTTP request to server. The server may accept the HTTP request and communicate to client device 506 one or more Hyper Text Markup Language (HTML) files responsive to the HTTP request. Client device 506 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social networking system 502 may be a network-addressable computing system that can host an online social network. Social networking system 502 may generate, store, receive, and send social-networking data, such as, for example, user-profile data, concept-profile data, social-graph information, or other suitable data related to the online social network. Social networking system 502 may be accessed by the other components of network environment 500 either directly or via network 504. In particular embodiments, social networking system 502 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 502 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 506, a social networking system 502, or a third-party system 508 to manage, retrieve, modify, add, or delete, the information stored in data store.

In particular embodiments, social networking system 502 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 502 may provide users of the online social network the ability to communicate and interact with other users. In particular embodiments, users may join the online social network via social networking system 502 and then add connections (e.g., relationships) to a number of other users of social networking system 502 whom they want to be connected to. Herein, the term “friend” may refer to any other user of social networking system 502 with whom a user has formed a connection, association, or relationship via social networking system 502.

In particular embodiments, social networking system 502 may provide users with the ability to take actions on various types of items or objects, supported by social networking system 502. As an example and not by way of limitation, the items and objects may include groups or social networks to which users of social networking system 502 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 502 or by an external system of third-party system 508, which is separate from social networking system 502 and coupled to social networking system 502 via a network 504.

In particular embodiments, social networking system 502 may be capable of linking a variety of entities. As an example and not by way of limitation, social networking system 502 may enable users to interact with each other as well as receive content from third-party systems 508 or other entities, or to allow users to interact with these entities through an application programming interfaces (API) or other communication channels.

In particular embodiments, a third-party system 508 may include one or more types of servers, one or more data stores, one or more interfaces, including but not limited to APIs, one or more web services, one or more content sources, one or more networks, or any other suitable components, e.g., that servers may communicate with. A third-party system 508 may be operated by a different entity from an entity operating social networking system 502. In particular embodiments, however, social networking system 502 and third-party systems 508 may operate in conjunction with each other to provide social-networking services to users of social networking system 502 or third-party systems 508. In this sense, social networking system 502 may provide a platform, or backbone, which other systems, such as third-party systems 508, may use to provide social-networking services and functionality to users across the Internet.

In particular embodiments, a third-party system 508 may include a third-party content object provider. A third-party content object provider may include one or more sources of content objects, which may be communicated to a client device 506. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 502 also includes user-generated content objects, which may enhance a user's interactions with social networking system 502. User-generated content may include anything a user can add, upload, send, or “post” to social networking system 502. As an example and not by way of limitation, a user communicates posts to social networking system 502 from a client device 506. Posts may include data such as status updates or other textual data, location information, photos, videos, links, music or other similar data or media. Content may also be added to social networking system 502 by a third-party through a “communication channel,” such as a newsfeed or stream.

In particular embodiments, social networking system 502 may include a variety of servers, sub-systems, programs, modules, logs, and data stores. In particular embodiments, social networking system 502 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social networking system 502 may also include suitable components such as network interfaces, security mechanisms, load balancers, failover servers, management-and-network-operations consoles, other suitable components, or any suitable combination thereof. In particular embodiments, social networking system 502 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 502 to one or more client devices 506 or one or more third-party system 508 via network 504. The web server may include a mail server or other messaging functionality for receiving and routing messages between social networking system 502 and one or more client devices 506. An API-request server may allow a third-party system 508 to access information from social networking system 502 by calling one or more APIs. An action logger may be used to receive communications from a web server about a user's actions on or off social networking system 502. In conjunction with the action log, a third-party-content-object log may be maintained of user exposures to third-party-content objects. A notification controller may provide information regarding content objects to a client device 506. Information may be pushed to a client device 506 as notifications, or information may be pulled from client device 506 responsive to a request received from client device 506. Authorization servers may be used to enforce one or more privacy settings of the users of social networking system 502. A privacy setting of a user determines how particular information associated with a user can be shared. The authorization server may allow users to opt in to or opt out of having their actions logged by social networking system 502 or shared with other systems (e.g., third-party system 508), such as, for example, by setting appropriate privacy settings. Third-party-content-object stores may be used to store content objects received from third parties, such as a third-party system 508. Location stores may be used for storing location information received from client devices 506 associated with users. Advertisement-pricing modules may combine social information, the current time, location information, or other suitable information to provide relevant advertisements, in the form of notifications, to a user.

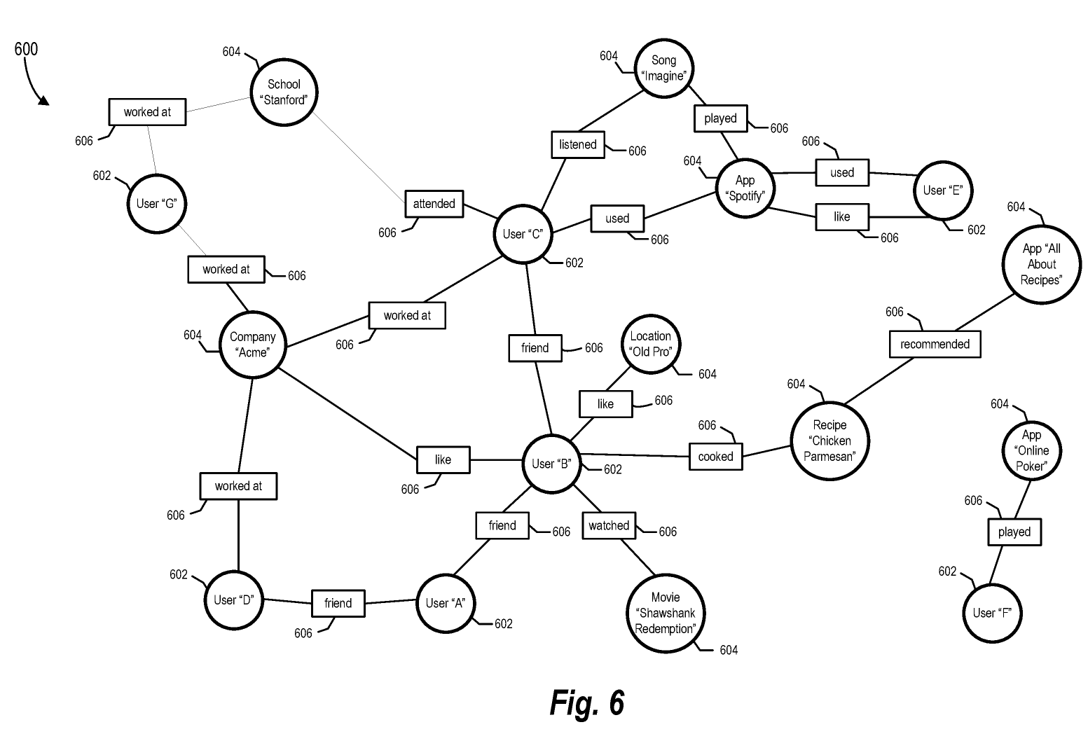

FIG. 6 illustrates example social graph 600. In particular embodiments, social networking system 502 may store one or more social graphs 600 in one or more data stores. In particular embodiments, social graph 600 may include multiple nodes—which may include multiple user nodes 602 or multiple concept nodes 604—and multiple edges 606 connecting the nodes. Example social graph 600 illustrated in FIG. 6 is shown, for didactic purposes, in a two-dimensional visual map representation. In particular embodiments, a social networking system 502, client device 506, or third-party system 508 may access social graph 600 and related social-graph information for suitable applications. The nodes and edges of social graph 600 may be stored as data objects, for example, in a data store (such as a social-graph database). Such a data store may include one or more searchable or query able indexes of nodes or edges of social graph 600.

In particular embodiments, a user node 602 may correspond to a user of social networking system 502. As an example and not by way of limitation, a user may be an individual (human user), an entity (e.g., an enterprise, business, or third-party application), or a group (e.g., of individuals or entities) that interacts or communicates with or over social networking system 502. In particular embodiments, when a user registers for an account with social networking system 502, social networking system 502 may create a user node 602 corresponding to the user, and store the user node 602 in one or more data stores. Users and user nodes 602 described herein may, where appropriate, refer to registered users and user nodes 602 associated with registered users. In addition or as an alternative, users and user nodes 602 described herein may, where appropriate, refer to users that have not registered with social networking system 502. In particular embodiments, a user node 602 may be associated with information provided by a user or information gathered by various systems, including social networking system 502. As an example and not by way of limitation, a user may provide his or her name, profile picture, contact information, birth date, sex, marital status, family status, employment, education background, preferences, interests, or other demographic information. In particular embodiments, a user node 602 may be associated with one or more data objects corresponding to information associated with a user. In particular embodiments, a user node 602 may correspond to one or more webpages.

In particular embodiments, a concept node 604 may correspond to a concept. As an example and not by way of limitation, a concept may correspond to a place (such as, for example, a movie theater, restaurant, landmark, or city); a website (such as, for example, a website associated with social networking system 502 or a third-party website associated with a web-application server); an entity (such as, for example, a person, business, group, sports team, or celebrity); a resource (such as, for example, an audio file, video file, digital photo, text file, structured document, or application) which may be located within social networking system 502 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 604 may be associated with information of a concept provided by a user or information gathered by various systems, including social networking system 502. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 604 may be associated with one or more data objects corresponding to information associated with concept node 604. In particular embodiments, a concept node 604 may correspond to one or more webpages.

In particular embodiments, a node in social graph 600 may represent or be represented by a webpage (which may be referred to as a “profile page”). Profile pages may be hosted by or accessible to social networking system 502. Profile pages may also be hosted on third-party websites associated with a third-party system 508. As an example and not by way of limitation, a profile page corresponding to a particular external webpage may be the particular external webpage and the profile page may correspond to a particular concept node 604. Profile pages may be viewable by all or a selected subset of other users. As an example and not by way of limitation, a user node 602 may have a corresponding user-profile page in which the corresponding user may add content, make declarations, or otherwise express himself or herself. As another example and not by way of limitation, a concept node 604 may have a corresponding concept-profile page in which one or more users may add content, make declarations, or express themselves, particularly in relation to the concept corresponding to concept node 604.

In particular embodiments, a concept node 604 may represent a third-party webpage or resource hosted by a third-party system 508. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 506 to send to social networking system 502 a message indicating the user's action. In response to the message, social networking system 502 may create an edge (e.g., an “eat” edge) between a user node 602 corresponding to the user and a concept node 604 corresponding to the third-party webpage or resource and store edge 606 in one or more data stores.

In particular embodiments, a pair of nodes in social graph 600 may be connected to each other by one or more edges 606. An edge 606 connecting a pair of nodes may represent a relationship between the pair of nodes. In particular embodiments, an edge 606 may include or represent one or more data objects or attributes corresponding to the relationship between a pair of nodes. As an example and not by way of limitation, a first user may indicate that a second user is a “friend” of the first user. In response to this indication, social networking system 502 may send a “friend request” to the second user. If the second user confirms the “friend request,” social networking system 502 may create an edge 606 connecting the first user's user node 602 to the second user's user node 602 in social graph 600 and store edge 606 as social-graph information in one or more of data stores. In the example of FIG. 6, social graph 600 includes an edge 606 indicating a friend relation between user nodes 602 of user “A” and user “B” and an edge indicating a friend relation between user nodes 602 of user “C” and user “B.” Although this disclosure describes or illustrates particular edges 606 with particular attributes connecting particular user nodes 602, this disclosure contemplates any suitable edges 606 with any suitable attributes connecting user nodes 602. As an example and not by way of limitation, an edge 606 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 600 by one or more edges 606.

In particular embodiments, an edge 606 between a user node 602 and a concept node 604 may represent a particular action or activity performed by a user associated with user node 602 toward a concept associated with a concept node 604. As an example and not by way of limitation, as illustrated in FIG. 6, a user may “like,” “attended,” “played,” “listened,” “cooked,” “worked at,” or “watched” a concept, each of which may correspond to an edge type or subtype. A concept-profile page corresponding to a concept node 604 may include, for example, a selectable “check in” icon (such as, for example, a clickable “check in” icon) or a selectable “add to favorites” icon. Similarly, after a user clicks these icons, social networking system 502 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 502 may create a “listened” edge 606 and a “used” edge (as illustrated in FIG. 6) between user nodes 602 corresponding to the user and concept nodes 604 corresponding to the song and application to indicate that the user listened to the song and used the application. Moreover, social networking system 502 may create a “played” edge 606 (as illustrated in FIG. 6) between concept nodes 604 corresponding to the song and the application to indicate that the particular song was played by the particular application. In this case, “played” edge 606 corresponds to an action performed by an external application (SPOTIFY) on an external audio file (the song “Imagine”). Although this disclosure describes particular edges 606 with particular attributes connecting user nodes 602 and concept nodes 604, this disclosure contemplates any suitable edges 606 with any suitable attributes connecting user nodes 602 and concept nodes 604. Moreover, although this disclosure describes edges between a user node 602 and a concept node 604 representing a single relationship, this disclosure contemplates edges between a user node 602 and a concept node 604 representing one or more relationships. As an example and not by way of limitation, an edge 606 may represent both that a user likes and has used at a particular concept. Alternatively, another edge 606 may represent each type of relationship (or multiples of a single relationship) between a user node 602 and a concept node 604 (as illustrated in FIG. 6 between user node 602 for user “E” and concept node 604 for “SPOTIFY”).

In particular embodiments, social networking system 502 may create an edge 606 between a user node 602 and a concept node 604 in social graph 600. As an example and not by way of limitation, a user viewing a concept-profile page (such as, for example, by using a web browser or a special-purpose application hosted by the user's client device 506) may indicate that he or she likes the concept represented by the concept node 604 by clicking or selecting a “Like” icon, which may cause the user's client device 506 to send to social networking system 502 a message indicating the user's liking of the concept associated with the concept-profile page. In response to the message, social networking system 502 may create an edge 606 between user node 602 associated with the user and concept node 604, as illustrated by “like” edge 606 between the user and concept node 604. In particular embodiments, social networking system 502 may store an edge 606 in one or more data stores. In particular embodiments, an edge 606 may be automatically formed by social networking system 502 in response to a particular user action. As an example and not by way of limitation, if a first user uploads a picture, watches a movie, or listens to a song, an edge 606 may be formed between user node 602 corresponding to the first user and concept nodes 604 corresponding to those concepts. Although this disclosure describes forming particular edges 606 in particular manners, this disclosure contemplates forming any suitable edges 606 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social networking system 502). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 502 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 502) or RSVP (e.g., through social networking system 502) to an event associated with the advertisement. In addition or as an alternative, an advertisement may include social-networking-system context directed to the user. As an example and not by way of limitation, an advertisement may display information about a friend of the user within social networking system 502 who has taken an action associated with the subject matter of the advertisement.

In particular embodiments, social networking system 502 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 508 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, as described above, social networking system 502 may measure or quantify social-graph affinity using an affinity score. The affinity score may represent or quantify the strength of a relationship between particular objects associated with the online social network (e.g., the strength of a relationship between nodes in the social graph). The affinity score may also represent a probability or function that measures a predicted probability that a user will perform a particular action based on the user's interest in the action. In this way, a user's future actions may be predicted based on the user's prior actions, where the affinity score may be calculated at least in part based on a history of the user's actions. Affinity scores may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 502 may use a variety of factors to calculate an affinity score. These factors may include, for example, user actions, types of relationships between objects, location information, other suitable factors, or any combination thereof. In particular embodiments, different factors may be weighted differently when calculating the affinity score. The weights for each factor may be static or the weights may change according to, for example, the user, the type of relationship, the type of action, the user's location, and so forth. Ratings for the factors may be combined according to their weights to determine an overall affinity score associated with an offer and a user. As an example and not by way of limitation, particular user actions may be assigned both a rating and a weight while a relationship associated with the particular user action is assigned a rating and a correlating weight (e.g., so the weights total 100%). To calculate the affinity score of a user towards a particular object (e.g., an offer), the rating assigned to the user's actions may comprise, for example, 60% of the overall affinity score, while the relationship between the user and the object may comprise 40% of the overall affinity score. In particular embodiments, the social networking system 502 may consider a variety of variables when determining weights for various factors used to calculate an affinity score, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, an affinity score may include a decay factor that causes the strength of the signal provided by particular actions to decay with time, such that more recent actions are more relevant when calculating the affinity score. The ratings and weights may be continuously updated based on continued tracking of the actions upon which the affinity score is based. Any type of process or algorithm may be employed for assigning, combining, averaging, and so forth the ratings for each factor and the weights assigned to the factors. In particular embodiments, social networking system 502 may determine affinity scores using machine-learning algorithms trained on historical actions and past user responses, or data farmed from users by exposing them to various options and measuring responses. Although this disclosure describes calculating affinity scores in a particular manner, this disclosure contemplates calculating affinity scores in any suitable manner.

In particular embodiments, social networking system 502 may calculate an affinity score based on a user's actions. Social networking system 502 may monitor such actions on the online social network, on a third-party system 508, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 502 may calculate an affinity score based on the user's actions with particular types of content. The content may be associated with the online social network, a third-party system 508, or another suitable system. The content may include users, profile pages, posts, news stories, headlines, instant messages, chat room conversations, emails, advertisements, pictures, video, music, other suitable objects, or any combination thereof. Social networking system 502 may analyze a user's actions to determine whether one or more of the actions indicate an affinity for subject matter, content, other users, and so forth. As an example and not by way of limitation, if a user may make frequently posts content related to “coffee” or variants thereof, social networking system 502 may determine the user can have a high affinity score with respect to offers related to “coffee”. Particular actions or types of actions may be assigned a higher weight and/or rating than other actions, which may affect the overall calculated affinity score. As an example and not by way of limitation, if a first user emails a second user, the weight or the rating for the action may be higher than if the first user simply views the user-profile page for the second user.

In particular embodiments, social networking system 502 may calculate an affinity score based on the type of relationship between particular objects. Referencing the social graph 600, social networking system 502 may analyze the number and/or type of edges 606 connecting particular user nodes 602 and concept nodes 604 when calculating an affinity score. As an example and not by way of limitation, user nodes 602 that are connected by a spouse-type edge (representing that the two users are married) may be assigned a higher affinity score than a user node 602 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the affinity score for that object. As an example and not by way of limitation, if a user is tagged in first photo, but merely likes a second photo, social networking system 502 may determine that the user has a higher affinity score with respect to the first photo than the second photo because having a tagged-in-type relationship with content may be assigned a higher weight and/or rating than having a like-type relationship with content. In particular embodiments, social networking system 502 may calculate an affinity score for a first user based on the relationship one or more second users have with a particular object. In other words, the connections and affinity scores other users have with an object may affect the first user's affinity score for the object. As an example and not by way of limitation, if a first user is connected to or has a high affinity score for one or more second users, and those second users are connected to or have a high affinity score for a particular object, social networking system 502 may determine that the first user should also have a relatively high affinity score for the particular object. In particular embodiments, the affinity score may be based on the degree of separation between particular objects. The lower affinity score may represent the decreasing likelihood that the first user will share an interest in content objects of the user that is indirectly connected to the first user in the social graph 600. As an example and not by way of limitation, social-graph entities that are closer in the social graph 600 (i.e., fewer degrees of separation) may have a higher affinity scores than entities that are further apart in the social graph 600.

In particular embodiments, social networking system 502 may calculate an affinity score based on location information. Objects that are geographically closer to each other may be considered to be more related, or of more interest, to each other than more distant objects. In particular embodiments, the affinity score of a user relative to a particular object may be based on the proximity of the object's location to a current location associated with the user (or the location of a client device 506 of the user). A first user may be more interested in other users or concepts that are closer to the first user. As an example and not by way of limitation, if a user is one mile from an airport and two miles from a gas station, social networking system 502 may determine that the user has a higher affinity score for the airport than the gas station based on the proximity of the airport to the user.

In particular embodiments, social networking system 502 may perform particular actions with respect to a user based on affinity information. Affinity scores may be used to predict whether a user will perform a particular action based on the user's interest in the action. An affinity score may be used when generating or presenting any type of objects to a user, such as advertisements, search results, news stories, media, messages, notifications, or other suitable objects. The affinity score may also be utilized to rank and order such objects, as appropriate. In this way, social networking system 502 may provide information that is relevant to user's interests and current circumstances, increasing the likelihood that they will find such information of interest. In particular embodiments, social networking system 502 may generate content based on affinity information. Content objects may be provided or selected based on affinity scores specific to a user. As an example and not by way of limitation, the affinity score may be used to generate media for the user, where the user may be presented with media for which the user has a high overall affinity score with respect to the media object. As another example and not by way of limitation, the affinity score may be used to generate advertisements for the user, where the user may be presented with advertisements for which the user has a high overall affinity score with respect to the advertised object. In particular embodiments, social networking system 502 may generate search results based on affinity information. Search results for a particular user may be scored or ranked based on the affinity score associated with the search results with respect to the querying user. As an example and not by way of limitation, search results corresponding to objects with higher affinity scores may be ranked higher on a search-results page than results corresponding to objects having lower affinity scores.

In particular embodiments, social networking system 502 may calculate an affinity score in response to a request for an affinity score from a particular system or process. To predict the likely actions a user may take (or may be the subject of) in a given situation, any process may request a calculated affinity score for a user. The request may also include a set of weights to use for various factors used to calculate the affinity score. This request may come from a process running on the online social network, from a third-party system 508 (e.g., via an API or other communication channel), or from another suitable system. In response to the request, social networking system 502 may calculate the affinity score (or access the affinity information if it has previously been calculated and stored). In particular embodiments, social networking system 502 may measure an affinity with respect to a particular process. Different processes (both internal and external to the online social network) may request an affinity score for a particular object or set of objects. Social networking system 502 may provide a measure of affinity that is relevant to the particular process that requested the measure of affinity. In this way, each process receives a measure of affinity that is tailored for the different context in which the process will use the measure of affinity.

In connection with social-graph affinity and affinity scores, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 604 corresponding to a particular photo may have a privacy setting specifying that the photo may only be accessed by users tagged in the photo and their friends. In particular embodiments, privacy settings may allow users to opt in or opt out of having their actions logged by social networking system 502 or shared with other systems (e.g., third-party system 508). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 508, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 502 may send a request to the data store for the object. The request may identify the user associated with the request and may only be sent to the user (or a client device 506 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
monitoring, by at least one processor of a social networking system, social networking system activity associated with a social networking system user represented by a user node within a social graph of the social networking system, the social graph comprising a plurality of nodes connected by a plurality of edges, and wherein the user node comprises data representative of the monitored social networking activity of the social networking system user;
identifying, by the at least one processor and based at least in part on the monitored social networking system activity, a plurality of offers that are relevant to the social networking system user, wherein each of the plurality of offers is represented by an offer node within the social graph;
calculating, by the at least one processor and based on the social graph, an affinity score for each of the plurality of identified offers with respect to the social networking system user; and
generating, by the at least one processor, a customized offer discovery graphical user interface accessible by the social networking system user via the social networking system, the customized offer discovery graphical user interface comprising the plurality of identified offers organized in accordance with the calculated affinity scores.

2. The method as recited in claim 1, further comprising:
identifying one or more edges of the plurality of edges that connect the user node to one or more co-user nodes; and
identifying data within the one or more co-user nodes representative of monitored social networking activity associated with the one or more co-users.

3. The method as recited in claim 2, wherein identifying a plurality of offers that are relevant to the social networking system user is further based on the monitored social networking activity associated with the one or more co-users.

4. The method as recited in claim 1, wherein identifying a plurality of offers that are relevant to the social networking system user further comprises identifying offers that correspond with one or more of: the social networking system user's demographic, the social networking system user's geographic location, the social networking system user's offer use history, or the social networking system user's profile information.

5. The method as recited in claim 1, wherein calculating the affinity score for each of the plurality of identified offers with respect to the social networking system user comprises, for each identified offer:
identifying, from the user node, one or more characteristics of the social networking system user;
identifying an offer node representing the identified offer, wherein the offer node comprises one or more characteristics specific to the offer;
determining one or more corresponding characteristics between the user node and the offer node; and
adding a weighted value to the affinity score for each of the identified one or more corresponding characteristics between the user node and the offer node.

6. The method as recited in claim 5, wherein generating the offer discovery graphical user interface comprises:
ranking the plurality of offers based on the calculated affinity score for each of the plurality of identified offers; and
listing the ranked plurality of offers within the offer discovery graphical user interface such that a top-ranked offer is listed first.

7. The method as recited in claim 1, further comprising:
identifying a current geographic location of the social networking system user;
identifying at least one offer that is relevant to the current geographic location of the social networking system user;
generating an alert comprising the identified at least one offer; and
presenting the generated alert to the social networking system user while the social networking system user is within a geographic radius associated with the at least one offer.

8. The method as recited in claim 1, further comprising:
identifying at least one sponsored offer that is relevant to the social networking system user,
wherein generating the offer discovery graphical user interface further comprises adding the at least one sponsored offer to the graphical user interface.

9. A system comprising:
at least one processor; and
at least one non-transitory computer-readable storage medium storing instructions thereon that, when executed by the at least one processor, cause the system to:
monitor social networking system activity associated with a social networking system user represented by a user node within a social graph of a social networking system, the social graph comprising a plurality of nodes connected by a plurality of edges, and wherein the user node comprises data representative of monitored social networking activity of the user;
identify, based at least in part on the monitored social networking system activity, a plurality of offers that are relevant to the social networking system user, wherein each of the plurality of offers is represented by an offer node within the social graph;
calculate, based on the social graph, an affinity score for each of the plurality of identified offers with respect to the social networking system user; and
generate a customized offer discovery graphical user interface accessible by the social networking system user via the social networking system, the customized offer discovery graphical user interface comprising the plurality of identified offers organized in accordance with the calculated affinity scores.

10. The system as recited in claim 9, wherein the instructions that cause the system to monitor social networking system activity associated with a social networking system user further cause the system to:
identify one or more edges of the plurality of edges that connect the user node to one or more co-user nodes; and
identify data within the one or more co-user nodes for data representative of monitored social networking activity associated with the one or more co-users.

11. The system as recited in claim 10, wherein identifying the plurality of offers that are relevant to the social networking system user is further based on the monitored social networking activity associated with the one or more co-users.

12. The system as recited in claim 11, wherein identifying a plurality of offers that are relevant to the social networking system user further comprises identifying offers that correspond with one or more of: the social networking system user's demographic, the social networking system user's geographic location, the social networking system user's offer use history, or the social networking system user's profile information.

13. The system as recited in claim 12, wherein the instructions that cause the system to calculate the affinity score for each of the plurality of identified offers with respect to the user further causes the system to, for each identified offer:
identify, from the user node, one or more characteristics of the social networking system user;
identify an offer node representing the identified offer, wherein the offer node representing the identified offer comprises one or more characteristics specific to the offer;
determine one or more corresponding characteristics between the user node and the offer node; and
add a weighted value to the affinity score for each of the identified one or more corresponding characteristics between the user node and the offer node.

14. The system as recited in claim 13, wherein generating the offer discovery graphical user interface comprises:
ranking the plurality of offers based on the calculated affinity score for each of the plurality of identified offers; and
listing the ranked plurality of offers within the offer discovery graphical user interface such that a top-ranked offer is listed first.

15. The system as recited in claim 14, wherein the at least one non-transitory computer-readable storage medium further stores instructions thereon that, when executed by the at least one processor, cause the system to:
identify a current geographic location of the social networking system user;
identify at least one offer that is relevant to the current geographic location of the social networking system user;
generate an alert comprising the identified at least one offer; and
present the generated alert to the social networking system user while the social networking system user is within a geographic radius associated with the at least one offer.

16. The system as recited in claim 15, wherein the at least one non-transitory computer-readable storage medium further stores instructions thereon that, when executed by the at least one processor, cause the system to:
identify at least one sponsored offer that is relevant to the social networking system user; and
add the at least one sponsored offer to the offer discovery graphical user interface.

17. A non-transitory computer-readable medium storing instructions thereon that, when executed by at least one processor, cause a computer system to:
monitor social networking system activity associated with a social networking system user represented by a user node within a social graph of a social networking system, the social graph comprising a plurality of nodes connected by a plurality of edges, and wherein the user node comprises data representative of the monitored social networking activity;
identify, based at least in part on the monitored social networking system activity, a plurality of offers that are relevant to the social networking system user, wherein each of the plurality of offers is represented by an offer node within the social graph;
calculate, based on the social graph, an affinity score for each of the plurality of identified offers with respect to the social networking system user; and
generate a customized offer discovery graphical user interface accessible by the social networking system user via the social networking system, the customized offer discovery graphical user interface comprising the plurality of identified offers organized in accordance with the calculated affinity scores.

18. The non-transitory computer-readable medium as recited in claim 17, wherein identifying the plurality of offers that are relevant to the social networking system user is further based, at least in part, on monitored social networking activity associated with one or more co-users of the social networking system user.

19. The non-transitory computer-readable medium as recited in claim 18, wherein identifying the plurality of offers that are relevant to the social networking system user comprises identifying offers that correspond with one or more of: the social networking system user's demographic, the social networking system user's geographic location, the social networking system user's offer use history, or the social networking system user's profile information.

20. The non-transitory computer-readable medium as recited in claim 19, wherein generating the customized offer discovery graphical user interface comprises:
ranking the plurality of offers based on the calculated affinity score for each of the plurality of identified offers; and
listing the ranked plurality of offers such that a top-ranked offer is listed first.
